(19) United States
(12) Patent Application Publication
(10) Pub. No.: US 2023/0102790 A1
(43) Pub. Date: Mar. 30, 2023

(54) SYSTEM AND METHOD FOR DETERMINING POTENTIAL REVENUE FROM SALE OPPORTUNITY

(71) Applicant: AYARA INC., Milpitas, CA (US)

(72) Inventors: Rakesh Chand AMERINENI, Milpitas, CA (US); Jaya Prasad VEJENDLA, Milpitas, CA (US); Srinivas VEMURI, Milpitas, CA (US)

(73) Assignee: AYARA INC., Milpitas, CA (US)

(21) Appl. No.: 17/388,413

(22) Filed: Jul. 29, 2021

(51) Int. Cl. G06Q 30/06; G06Q 30/02

(52) U.S. Cl. CPC G06Q 30/0611; G06Q 30/0201; G06Q 30/0239

(57) ABSTRACT

A system and a method for determining potential revenue from a sales opportunity at a stage of generating a quotation therefor are provided. The system comprises an application programming interface configured to receive a draft quotation from a CRM application. The present system bundles two or more items of the draft quotation based on one or more predefined revenue allocation rules for the draft quotation; apply the variable consideration information for each of the bundled items to determine a revenue adjustment amount and a timeline for realization of revenue; group items based on substantially matching timelines therefor for realization of revenue; determine revenue recognition for each group based on price information and determined revenue adjustment amount for each of the items therein; and generate a revenue forecast resultant of the approval of the draft quotation based on the determined revenue recognition.

### TECHNICAL FIELD

The present disclosure relates in general to business accounting, and more specifically to a system and method for determining potential revenue from a sales opportunity at a stage of generating a quotation therefor. In particular, the system and the method of present disclosure allows for identifying, analyzing, allocating, calculating and scheduling the revenue on a quotation in real-time

### BACKGROUND

Every business provides some kind of goods and/or services to their customers. The goods and services often include several elements that can be ordered to the customer's specifications. During the ordering process, it is common for a customer to select and change various components or service options over a period of time until the goods are delivered and services are established or performed. As the needs of a customer change over time, the customer can choose to add or remove services, or upgrade some of the products or components in the products. All these factors and more can affect the pricing and timing of the business's revenue. Furthermore, businesses that offer subscription- or license-based solutions operate under a different financial model than those selling one-time goods or services. Instead of a straightforward, single-use exchange, subscription revenue typically arrives up-front for services to be rendered in the future. Revenue recognition, in such cases, is often made more complicated when one take into account discounts and special packages.

The importance of revenue recognition cannot be overstated. The ability to accurately recognize revenue is vital to a business's financial performance. However, when one may combine the complexities of the new revenue recognition guidance with the complexities existing in one's business, there is an increased potential for errors and financial misstatements. Many businesses fail to maximize realization of maximum possible revenue from various revenue assets at least in part because management of such assets is not well supported by currently available approaches. Reliance on spreadsheets, manual journal entries, manual account reconciliations, etc. opens up the possibilities of errors in revenue recognition. Currently available tools for managing revenue recognition are spread across customer relationship management (CRM) systems, partner relationship management (PRM) systems, data warehouses, entitlement systems, billing systems, and even spreadsheets or the like. Thus, revenue recognition presents a number of challenges that differ in substantial and important ways from the typical focus of the sales staff of a business.

Therefore, there is a need of a reliable and intuitive tool/mechanism for revenue recognition, which possibly allow for determining potential revenue from a sales opportunity at a stage of generating a quotation therefor.

### SUMMARY

In an aspect, a system for determining potential revenue from a sales opportunity at a stage of generating a quotation therefor is provided. The system comprises an application programming interface configured to receive a draft quotation having a plurality of items, price information for each of the plurality of items and variable consideration information associated with each of the plurality of items therein. The system also comprises a processing arrangement and a memory in signal communication with the processing arrangement. The memory stores computer-executable instructions, which, upon execution by the processing arrangement, cause the processing arrangement to: bundle two or more items from the plurality of items based, at least in part, on one or more predefined revenue allocation rules for the draft quotation; apply the variable consideration information for each of the bundled two or more items to determine a revenue adjustment amount and a timeline for realization of revenue for each of the items in the bundled two or more items; group at least two items of the bundled two or more items based on substantially matching timelines therefor for realization of revenue therefrom; determine revenue recognition for each of the groups of at least two items based on the price information and the determined revenue adjustment amount for each of the items therein; and generate a revenue forecast for the sales opportunity based on the determined revenue recognition for each of the groups of at least two items in the draft quotation.

In one or more embodiments, the variable consideration information comprises one or more parameters including one of rebate information, discount information and payment term information for each of the plurality of items in the draft quotation.

In one or more embodiments, for applying the variable consideration information for each of the bundled two or more items, the processing arrangement is further caused to: define one or more accounting rules to be applied to each of the bundled two or more items, as determined from the variable consideration information associated therewith; and cascade the defined one or more accounting rules, for each of the items in the corresponding bundled two or more items.

In one or more embodiments, the defined one or more accounting rules comprises at least one of amortization rule information and amortization method information for each of the corresponding bundled two or more items.

In one or more embodiments, the one or more predefined revenue allocation rules are based on at least one of department information related to the sales opportunity, purchase order information related to the sales opportunity and region information related to the sales opportunity.

In one or more embodiments, the revenue adjustment amount for a given item is determined based on one or more of the rebate information and the discount information for the corresponding given item, in the variable consideration information.

In one or more embodiments, the one or more parameters related to the variable consideration information to be associated with each of the plurality of items in the draft quotation are defined based on corresponding rules based attributes for each of the plurality of items therein.

In one or more embodiments, the processing arrangement is further caused to implement a natural language processing engine to analyze a term sheet for the draft quotation to determine the one or more parameters related to the variable consideration information associated with each of the plurality of items therein.

In one or more embodiments, the processing arrangement is further caused to consider a rank of each of two or more conflicting parameters, in the variable consideration information, for any one of the items in the bundled two or more items while applying the variable consideration information.

In one or more embodiments, grouping the at least two items of the bundled two or more items is further based on one or more predefined revenue recognition timeframes for the draft quotation, Herein, the one or more predefined revenue recognition timeframes are defined in any one of a day, a week, a month, a quarter and a year.

In another aspect of the present disclosure, a computer-implemented method for determining potential revenue from a sales opportunity at a stage of generating a quotation therefor is provided. The method includes receiving a draft quotation having a plurality of items, price information for each of the plurality of items and variable consideration information associated with each of the plurality of items therein. The method further includes bundling, by a processing arrangement, two or more items from the plurality of items based, at least in part, on one or more predefined revenue allocation rules for the draft quotation. The method further includes applying, by the processing arrangement, the variable consideration information for each of the bundled two or more items to determine a revenue adjustment amount and a timeline for realization of revenue for each of the items in the bundled two or more items. The method further includes grouping, by the processing arrangement, at least two items of the bundled two or more items based on substantially matching timelines therefor for realization of revenue therefrom. The method further includes determining, by the processing arrangement, revenue recognition for each of the groups of at least two items based on the price information and the determined revenue adjustment amount for each of the items therein. The method further includes generating, by the processing arrangement, a revenue forecast for the sales opportunity based on the determined revenue recognition for each of the groups of at least two items in the draft quotation.

In one or more embodiments, the variable consideration information comprises one or more parameters including one of rebate information, discount information and payment term information for each of the plurality of items in the draft quotation

In one or more embodiments, applying the variable consideration information for each of the bundled two or more items further comprises: defining, by the processing arrangement, one or more accounting rules to be applied to each of the bundled two or more items, as determined from the variable consideration information associated therewith; and cascading, by the processing arrangement, the defined one or more accounting rules, for each of the items in the corresponding bundled two or more items.

In one or more embodiments, the defined one or more accounting rules comprises at least one of amortization rule information and amortization method information for each of the corresponding bundled two or more items.

In one or more embodiments, the one or more predefined revenue allocation rules are based on at least one of department information related to the sales opportunity, purchase order information related to the sales opportunity and region information related to the sales opportunity.

In one or more embodiments, the revenue adjustment amount for a given item is determined based on one or more of the rebate information and the discount information for the corresponding given item, in the variable consideration information.

In one or more embodiments, the one or more parameters related to the variable consideration information to be associated with each of the plurality of items in the draft quotation are defined based on corresponding rules based attributes for each of the plurality of items therein.

In one or more embodiments, the method further comprises implementing, by the processing arrangement, a natural language processing engine to analyze a term sheet for the draft quotation to determine the one or more parameters related to the variable consideration information associated with each of the plurality of items therein.

In one or more embodiments, the method further comprises considering, by the processing arrangement, a rank of each of two or more conflicting parameters, in the variable consideration information, for any one of the items in the bundled two or more items while applying the variable consideration information.

In one or more embodiments, grouping the at least two items of the bundled two or more items is further based on one or more predefined revenue recognition timeframes for the draft quotation, Herein, the one or more predefined revenue recognition timeframes are defined in any one of a day, a week, a month, a quarter and a year.

In yet another aspect, a computer program product comprising a non-transitory computer-readable storage medium having computer-readable instructions stored thereon is provided, the computer-readable instructions being executable by a computerized device comprising processing hardware to execute a method as described above.

The foregoing summary is illustrative only and is not intended to be in any way limiting. Further areas of applicability of the present disclosure will become apparent from the detailed description provided hereinafter. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 illustrates a system that may reside on and may be executed by a computer, which may be connected to a network, in accordance with one or more exemplary embodiments of the present disclosure;

FIG. 2 illustrates a high-level architecture of present system for determining potential revenue from a sales opportunity at a stage of generating a quotation therefor, in accordance with one or more embodiments of the present disclosure;

FIG. 3 illustrates a schematic flow diagram of a process for creating the accounting agreement, in accordance with one or more embodiments of the present disclosure;

FIG. 4 illustrates a schematic flow diagram of a process for assigning one or more revenue templates to quote lines, in accordance with one or more embodiments of the present disclosure;

FIG. 5 illustrates a schematic flow diagram of a process for applying variable consideration information to the quote lines, in accordance with one or more embodiments of the present disclosure;

FIG. 6 illustrates a schematic flow diagram of a process for bundling attributes and quote allocation, in accordance with one or more embodiments of the present disclosure; and

FIG. 7 illustrates a flowchart listing steps involved in a method for determining potential revenue from a sales opportunity at a stage of generating a quotation therefor, in accordance with one or more embodiments of the present disclosure.

In the appended figures, similar components and/or features may have the same numerical reference label. Further, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE INVENTION

In the following description, for purposes of explanation, numerous specific details are set forth in order to provide a thorough understanding of the present disclosure. It will be apparent, however, to one skilled in the art that the present disclosure is not limited to these specific details.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, Tensorflow™, Bazel, C, C++. Further, decoder in user device (as will be discussed) may use C, C++ or any processor specific ISA. Furthermore, assembly code inside C/C++ may be utilized for specific operation. Also, ASR (automatic speech recognition) and G2P decoder along with entire user system can be run in embedded Linux (any distribution), Android, iOS, Windows, or the like, without any limitations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

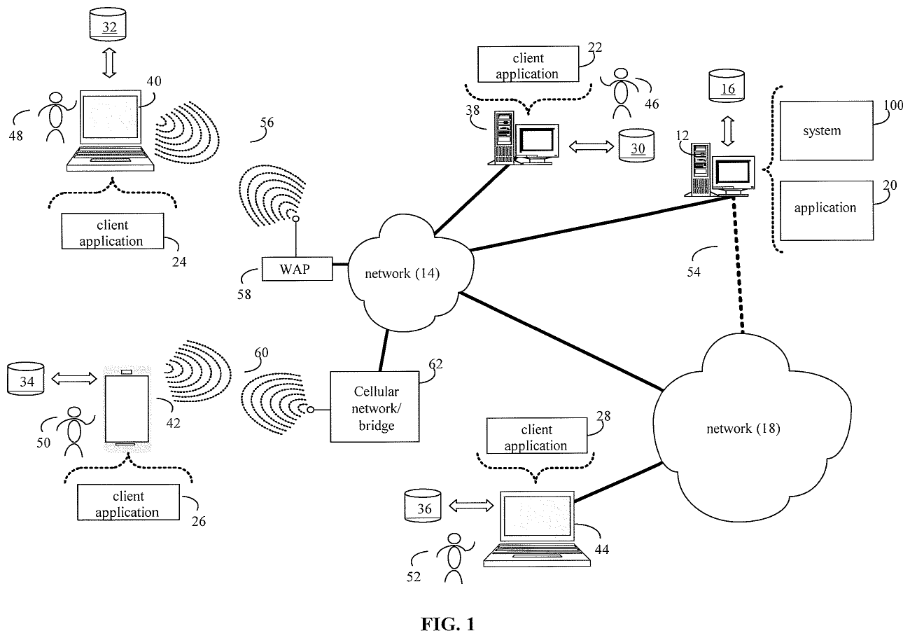

Referring now to the example implementation of FIG. 1, there is shown a system 100 that may reside on and may be executed by a computer (e.g., computer 12), which may be connected to a network (e.g., network 14) (e.g., the internet or a local area network). Examples of computer 12 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a processing arrangement 12, and hereinafter the terms “computer 12” and “processing arrangement 12” have been interchangeably used without any limitations.

In certain implementations, the processing arrangement 12 may be a physical or virtual device. In many implementations, the processing arrangement 12 may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, the instruction sets and subroutines of system 100, which may be stored on a memory 16, such as storage device 16 (with two terms being interchangeably used hereinafter), coupled to processing arrangement 12, may be executed by one or more processors (not shown) and one or more memory architectures included within processing arrangement 12. In some implementations, memory 16 may include but is not limited to: a hard disk drive; a flash drive, a tape drive; an optical drive; a RAID array (or other array); a random-access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, processing arrangement 12 may include a data store, such as a database (e.g., relational database, object-oriented database, triplestore database, etc.) and may be located within any suitable memory location, such as memory 16 coupled to processing arrangement 12. In some implementations, data, metadata, information, etc. described throughout the present disclosure may be stored in the data store. In some implementations, processing arrangement 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, system 100 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, processing arrangement 12 and memory 16 may refer to multiple devices, which may also be distributed throughout the network.

In some implementations, processing arrangement 12 may execute application 20 for revenue recognition from a sales opportunity (as discussed later in more detail). In some implementations, system 100 and/or application 20 may be accessed via one or more of client applications 22, 24, 26, 28. In some implementations, system 100 may be a standalone application, or may be an applet/application/script/extension that may interact with and/or be executed within application 20, a component of application 20, and/or one or more of client applications 22, 24, 26, 28. In some implementations, application 20 may be a standalone application, or may be an applet/application/script/extension that may interact with and/or be executed within system 100, a component of system 100, and/or one or more of client applications 22, 24, 26, 28. In some implementations, one or more of client applications 22, 24, 26, 28 may be a standalone application, or may be an applet/application/script/extension that may interact with and/or be executed within and/or be a component of system 100 and/or application 20. Examples of client applications 22, 24, 26, 28 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to user devices 38, 40, 42, 44, may be executed by one or more processors and one or more memory architectures incorporated into user devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of user devices 38, 40, 42, 44 (and/or processing arrangement 12) may include, but are not limited to, a personal computer (e.g., user device 38), a laptop computer (e.g., user device 40), a smart/data-enabled, cellular phone (e.g., user device 42), a notebook computer (e.g., user device 44), a tablet (not shown), a server (not shown), a television (not shown), a smart television (not shown), a media (e.g., video, photo, etc.) capturing device (not shown), and a dedicated network device (not shown). User devices 38, 40, 42, 44 may each execute an operating system, examples of which may include but are not limited to, Android®, Apple® iOS®, Mac® OS X®; Red Hat® Linux®, or a custom operating system.

In some implementations, one or more of client applications 22, 24, 26, 28 may be configured to effectuate some or all of the functionality of system 100 (and vice versa). Accordingly, in some implementations, system 100 may be a purely server-side application, a purely client-side application, or a hybrid server-side/client-side application that is cooperatively executed by one or more of client applications 22, 24, 26, 28 and/or system 100.

In some implementations, one or more of client applications 22, 24, 26, 28 may be configured to effectuate some or all of the functionality of application 20 (and vice versa). Accordingly, in some implementations, application 20 may be a purely server-side application, a purely client-side application, or a hybrid server-side/client-side application that is cooperatively executed by one or more of client applications 22, 24, 26, 28 and/or application 20. As one or more of client applications 22, 24, 26, 28, system 100, and application 20, taken singly or in any combination, may effectuate some or all of the same functionality, any description of effectuating such functionality via one or more of client applications 22, 24, 26, 28, system 100, application 20, or combination thereof, and any described interaction(s) between one or more of client applications 22, 24, 26, 28, system 100, application 20, or combination thereof to effectuate such functionality, should be taken as an example only and not to limit the scope of the disclosure.

In some implementations, one or more of users 46, 48, 50, 52 may access processing arrangement 12 (e.g., using one or more of user devices 38, 40, 42, 44) directly through network 14 or through secondary network 18. Further, processing arrangement 12 may be connected to network 14 through secondary network 18, as illustrated with phantom link line 54. System 100 may include one or more user interfaces, such as browsers and textual or graphical user interfaces, through which users 46, 48, 50, 52 may access system 100.

In some implementations, the various user devices may be directly or indirectly coupled to communication network, such as communication network 14 and communication network 18, hereinafter simply referred to as network 14 and network 18, respectively. For example, user device 38 is shown directly coupled to network 14 via a hardwired network connection. Further, user device 44 is shown directly coupled to network 18 via a hardwired network connection. User device 40 is shown wirelessly coupled to network 14 via wireless communication channel 56 established between user device 40 and wireless access point (i.e., WAP) 58, which is shown directly coupled to network 14. WAP 58 may be, for example, an IEEE 802.11a, 802.11b, 802.11g, Wi-Fi®, RFID, and/or Bluetooth™ (including Bluetooth™ Low Energy) device that is capable of establishing wireless communication channel 56 between user device 40 and WAP 58. User device 42 is shown wirelessly coupled to network 14 via wireless communication channel 60 established between user device 42 and cellular network/bridge 62, which is shown directly coupled to network 14.

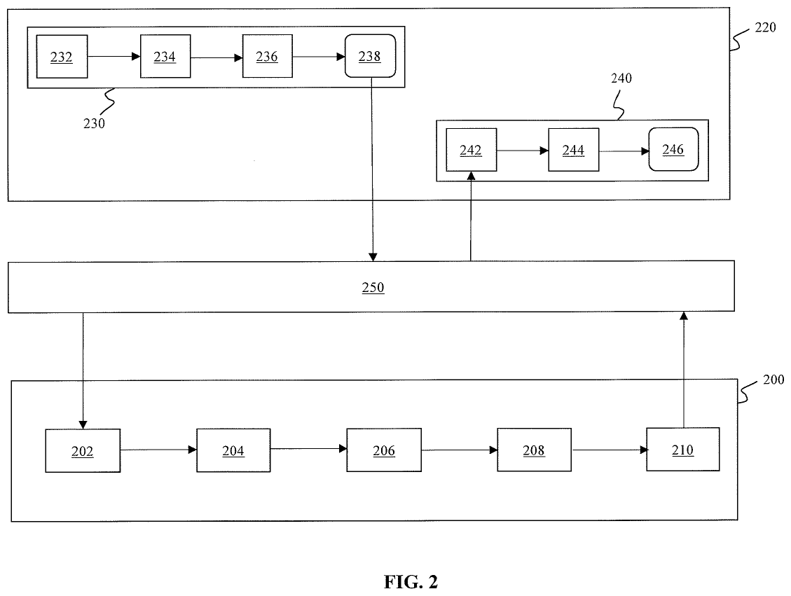

In reference to implementation of the present disclosure, FIG. 2 illustrates a high-level architecture of present system 200 for determining potential revenue from a sales opportunity at a stage of generating a quotation therefor, in accordance with one or more embodiments of the present disclosure. As used herein, the term “quotation” refers to a formal statement setting out the estimated cost for a particular job or service. A given quotation may include several line items, each of item requiring a sub-calculation. The quotation can refer to a specific product, an SKU or any single pricing line item, such as each single discount or tax calculation. It may be appreciated that the quotation may be generated based on the sales opportunity. The “sales opportunity” may be construed to mean any opportunity that a party has to provide goods and/or services to another party. In general, the quotation may include a grouping of one or more transactions for revenue accounting purpose as per applicable accounting guidelines or user policy. The term “revenue” as used herein means the amount of money or other consideration that an individual, company or other entity earns from its activities in any given period of time, mostly from sales of products and/or services to customers. The Financial Accounting Standards Board's (FASB) Statement of Financial Accounting states that revenues should be recognized when they are “realized or realizable” and “earned.” Embodiments of the present disclosure are directed to complying with accounting standards, such as those set forth in “FASB Accounting Standards Update, No. 2014-09, May 2014,” the contents of which are entirely incorporated by reference herein. Revenues are generally “realized or realizable” when products and/or services are exchanged for assets (such as cash) or claims to assets (such as promises to pay). Revenues are generally “earned” when an individual or entity has performed all duties that are necessary for a purchaser. From the time an agreement for services or products is reached, until the time performance by all parties is completed, revenue accounting is affected at each stage. Since companies need accurate revenue information throughout the revenue accounting life cycle, it would be particularly strategically advantageous for a company to determine potential revenue from a sales opportunity at a stage of generating a quotation therefor.

As illustrated in FIG. 2, the present system 200 is disposed in communication with a Customer Relationship Management (CRM) application 220. Herein, the CRM application 220 refers to a tool for automating, organizing, and synchronizing marketing, sales, customer service and technical support in a company. More specifically, the CRM application 220 described herein give a salesperson the decision-making freedom needed to achieve the best results under the best conditions, opening the way to planning and control. To that end, the salesperson can plan their opportunities based on their work process and also shape their risk accordingly. The CRM application 220 may include software, hardware, or combination of hardware and software. A particular example of the CRM application 220 which may be implemented for the purposes of the present disclosure is Salesforce® CRM; however, it may be appreciated that the given example shall not be construed as limiting to the present disclosure in any manner. In the embodiment of the present disclosure, the CRM application 220 provides a user interface to allow a user to generate the quotation. Herein, the term “user” includes, but is not limited to, client devices used to implement aspects of this disclosure, and persons (typically, salespersons) using such devices. The term “client device” includes one or more electronic devices, including, but not limited to, a PC, a smartphone, a PDA, etc., which can communicate with the system 200 of this disclosure, receive information from one or more systems of this disclosure, or transmit information to such systems.

In the present disclosure, the CRM application 220 may be implemented for generating a draft quotation. As would be appreciated, the draft quotation may have been generated by the user via the CRM application 220 in view of the sales opportunity. The draft quotation may refer to a quotation yet to be approved, and for which the user may wish to determine potential revenue therefrom (if approved) and accordingly adjust the draft quotation (if needed). As per the embodiments of the present disclosure, the draft quotation includes, but is not limited to, a plurality of items, price information for each of the plurality of items and variable consideration information associated with each of the plurality of items therein. Herein, the “items” being one or more products and/or services listed in the draft quotation, and the “price information” being the listed price corresponding to each of the items in the draft quotation. In one or more examples, each of the items in the draft quotation may be given a SKU (Stock Keeping Unit) number, which is a unique code, comprising letters and/or numbers, which can be assigned to a product or a service by a company for purposes of identification and inventory control. Further, the “variable consideration information” may be defined broadly to take many forms, such as discounts, credits, rebates, performance bonus, penalties, sales returns, refunds, price concessions, incentives, etc. Consideration is also considered variable if the amount an entity will receive is contingent on a future event occurring or not occurring, even though the amount itself is fixed. The draft quotation may also include other information, such as quote name, account opportunity, legal entity, etc. The CRM application 220 may also allow to edit items quote page, enter the start and end dates for ratable items, and corresponding discounts, etc.

Referring to FIG. 2, as illustrated, the CRM application 220 may generally involve two stages of operations, namely a first stage 230 and a second stage 240. Each of the first stage 230 and the second stage 240 may involve a number of steps represented as blocks therein. In particular, at block 232 of the first stage 230, the CRM application 220 is implemented to generate a quotation sheet. At block 234 of the first stage 230, the plurality of items and the price information for each of the plurality of items are added to the quotation sheet. At block 236 of the first stage 230, the terms and conditions (including discounts) related to the various items in the quotation sheet are added as variable consideration information for the draft quotation. Thereafter, at block 238 of the first stage 230, a trigger is executed by the user to send (synchronize) the generated draft quotation having the plurality of items, the price information for each of the plurality of items and the variable consideration information associated with each of the plurality of items therein, to the system 200 of the present disclosure.

Further, as illustrated in FIG. 2, the system 200 includes an application programming interface 250. Herein, the application programming interface (API) 250 acts as a software intermediary that allows the system 200 and the CRM application 220 to talk to each other. In particular, herein, the API 250 is configured to receive the draft quotation from the CRM application 220. Specifically, the API 250 may receive the draft quotation from the CRM application 220 upon execution of the trigger at the block 238, as described in the preceding paragraph. The API 250 may then send the information related to the generated draft quotation including the plurality of items, the price information for each of the plurality of items and the variable consideration information associated with each of the plurality of items therein, to the system 200 of the present disclosure. Although the term application programming interface (API) is used herein to describe various aspects of the present disclosure, it should be understood that the various aspects of the present disclosure may also be performed or configured using hardware and/or software modules that may not include every element of an application programming interface.

Herein, the system 200 is implemented for processing the received draft quotation, specifically in order to determine potential revenue therefrom. In the system 200, at block 202, the processing arrangement (as described earlier) is caused to bundle two or more items from the plurality of items, in the draft quotation, based, at least in part, on one or more predefined revenue allocation rules for the draft quotation. In one or more embodiments, the one or more predefined revenue allocation rules are based on at least one of department information related to the sales opportunity, purchase order information related to the sales opportunity and region information related to the sales opportunity. That is, the bundling of items in the draft quotation is based on customer information, including customer's PO number, customer's department and customer's location. Further, the one or more parameters related to the variable consideration information to be associated with each of the plurality of items in the draft quotation are defined based on corresponding rules based attributes for each of the plurality of items therein.

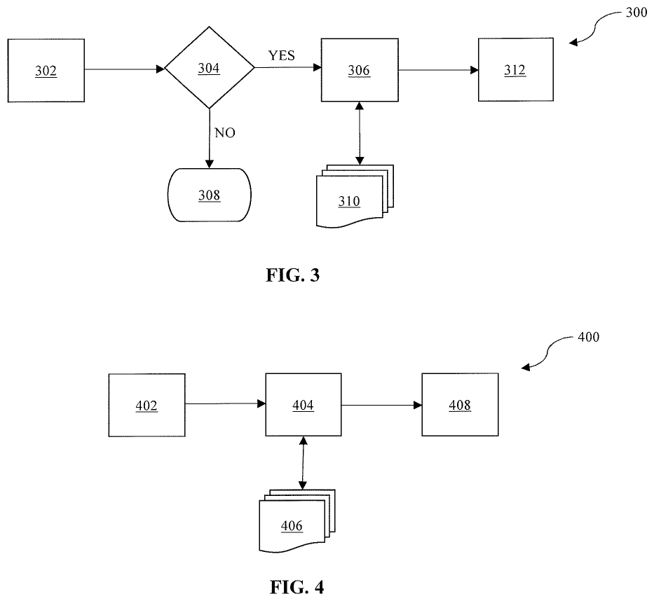

In particular, referring to FIG. 2, at the block 202, the system 200 may, first, move all quote lines in the draft quotation to a table (staging table). Then, the system 200 may create an accounting agreement, i.e. an arrangement with deal lines and deal numbers. Referring to FIG. 3, illustrated is a schematic flow diagram of a process 300 for creating the accounting agreement, in accordance with one or more embodiments of the present disclosure. Herein, at block 302, the quote lines, customer information and currency information in the staging table are validated. Thereafter, at block 304, it is checked if the result is validation in block 302. If YES, then the process 300 moves to block 306. Otherwise (i.e. if NO), the process 300 is aborted and the exception is displayed for user's reference as represented by block 308. At block 306, the quote lines are bundled based on bundling rules (as represented by numeral 310). Herein, the bundling rules 310 are generally defined based on customer name and deal numbers. In the present examples, the bundling rules 310 are multi-conditional which may be configured based on predefined criteria. Further, different configuration bundling rules for deals/quotes as well as post-booking (e.g., orders, PO numbers, etc.) may be defined. The system 200 may also allow a user to define custom definitions/attributes to add to the bundling rules 310. Further, at block 312, the draft revenue agreement, with agreement lines, is generated based on the bundled quote lines and the bundling rules 310.

For the purposes of the present disclosure, the term “revenue allocation rules” has been used in a broad sense to include all types of attribution basis, including predefined split percentage, fair value basis, etc. Such rules may be defined based on performance obligation. The term “performance obligation” includes a promise in a contract to transfer a good or service (to a customer, for example). In the present implementation, if any of the quote lines are bundled, then each bundled line is expanded to sub SKU level and then the attribution basis are applied as per the defined revenue allocation rules. Further, if any of the quote lines may require splitting based on performance obligation (POB), then the quote lines are expanded to the POB split SKU level as per the defined revenue allocation rules. And, if any of the quote lines may require grouping based on POB, the quote lines are grouped based on POB group SKU level as per the defined revenue allocation rules. Furthermore, the attribution basis are determined for each of the quote lines. Also, each of the quote lines is assigned a POB ID based on a default assignment logic. It may be understood that rules definition may be configured for each bundle by the user, as required. Further, it may be understood that if the attribution basis is a predefined split, then the split percentage basis is defined for each sub SKU. The system 200 of the present disclosure is configured to support multiple levels bundles, i.e. bundle within a bundle, as well as multiple levels split, i.e. split within a POB, with different attribution basis. It may be noted that the sub SKUs are mapped to the corresponding bundled SKU.

Referring back to FIG. 2, at block 204, the processing arrangement is caused to apply the variable consideration information for each of the bundled two or more items to determine a revenue adjustment amount and a timeline for realization of revenue for each of the items in the bundled two or more items. Herein, the variable consideration information comprises one or more parameters including one of rebate information, discount information and payment term information for each of the plurality of items in the draft quotation. As discussed, the “variable consideration information” may further be defined broadly to take many forms, such as discounts, credits, rebates, performance bonus, penalties, sales returns, refunds, price concessions, incentives, etc. In an embodiment, the processing arrangement is caused to implement a natural language processing engine may be implemented to analyze a term sheet for the draft quotation to determine the one or more parameters related to the variable consideration information associated with each of the plurality of items therein. Herein, the natural language processing engine may apply machine learning techniques for the purpose, and such techniques may be contemplated by a person skilled in the art and thus not described in detail for the brevity of the present disclosure.

In the present embodiments, for applying the variable consideration information for each of the bundled two or more items, the processing arrangement is further caused to: define one or more accounting rules to be applied to each of the bundled two or more items, as determined from the variable consideration information associated therewith; and cascade the defined one or more accounting rules, for each of the items in the corresponding bundled two or more items. Herein, the defined one or more accounting rules comprises at least one of amortization rule information and amortization method information for each of the corresponding bundled two or more items.

Referring to FIG. 4, illustrated is a schematic flow diagram of a process 400 for assigning one or more revenue templates to the quote lines, in accordance with one or more embodiments of the present disclosure. As illustrated, at block 402, the bundled items (quote lines) with corresponding performance obligation information are received. At block 404, for each quote line, a revenue template is assigned as per the variable consideration information defined in a rules engine (as represented by block 406). Herein, the revenue templates can be assigned at product level, product family level or business unit level and then cascaded accordingly. Further, the rules as defined in the rules engine 406 are configurable to specify revenue triggers, accounting rules, amortization rules, amortization methods, etc. Further, at block 408, at least the accounting rule, the amortization rule and the amortization method to be applied for each of the quote lines is determined.

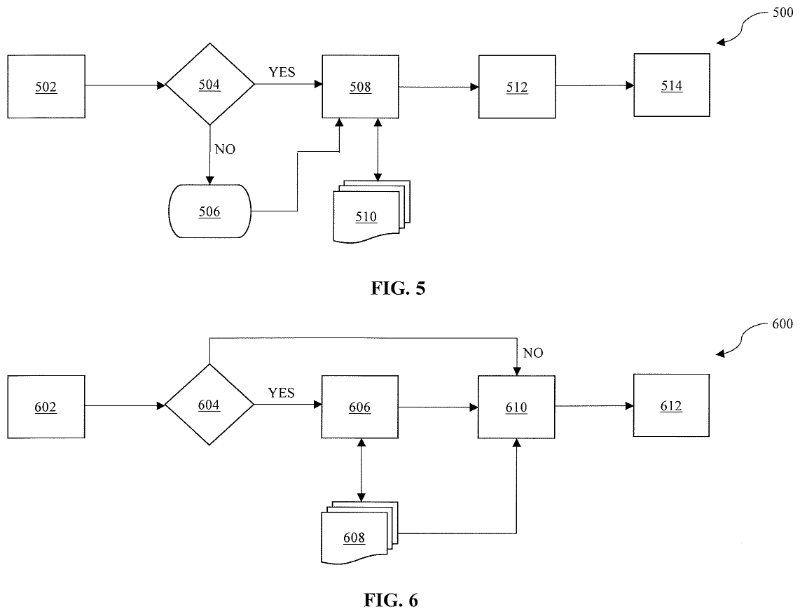

Referring to FIG. 5, illustrated is a schematic flow diagram of a process 500 for applying variable consideration information to the quote lines, in accordance with one or more embodiments of the present disclosure. At block 502, the quote lines with the applied revenue templates are received. At block 504, it is checked that each of the applied revenue templates has standard terms. If NO, then at block 506, the terms may be defined in the system 200. If YES, the process 500 moves to block 508. At the block 508, reason codes to be applied to the quote lines are determined from a rules engine (represented by block 510). Further, application level and account templates to be applied are determined. Herein, the application level defines whether the reason codes are applied to the entire draft quotation (contract), specific order in the draft quotation, or specific product family or specific product in the draft quotation; and, the template defines how much amount needs to be adjusted. The template could be in terms of percentage. It may be appreciated that the reason codes may be applied in case of partial payments made for open items, residual items created for an open item, differences posted on account without reference to an open item, etc. In an embodiment, the processing arrangement is further caused to consider a rank of each of two or more conflicting parameters, in the variable consideration information, for any one of the items in the bundled two or more items while applying the variable consideration information. For example, in case of multiple reason codes being applicable, ranking system may be used to determine the priority of the reason codes, and the reason code with the highest priority is applied. At block 512, the variable considerations (in particular, the revenue adjustment amounts) are calculated for each of the quote lines, which is given by the net price minus the variable consideration.

In one or more embodiments, the revenue adjustment amount for a given item is determined based on one or more of the rebate information and the discount information for the corresponding given item, in the variable consideration information. In the present disclosure, the system 200 may calculate allocations based on a standalone selling price (SSP), which is the price at which an entity sells a good or service separately to a customer, defined for each SKU combination after adjusting for any variable considerations. Further, the timeline for realization of revenue for each of the items in the bundled two or more items is determined herein. In some examples, the timeline for realization of revenue for a given item is determined based, at least in part, on the corresponding payment term information for the corresponding given item, in the variable consideration information. This provides a timeframe for how much and by when the revenue could be recognized for each of the items in the draft quotation.

Referring back to FIG. 2, at block 206, the processing arrangement is caused to group at least two items of the bundled two or more items based on substantially matching timelines therefor for realization of revenue therefrom. That is, the quote lines with substantially matching timelines therefor for realization of revenue are grouped together. In one or more embodiments, grouping the at least two items of the bundled two or more items is further based on one or more predefined revenue recognition timeframes for the draft quotation. Herein, the one or more predefined revenue recognition timeframes are defined in any one of a day, a week, a month, a quarter and a year. It may be appreciated that the given revenue recognition timeframes are typical standards employed in the business practices, and shall not be construed as limiting to the present disclosure.

Specifically, in the block 206, the system 200 may carve out bundle items based on bundle configurations. Referring to FIG. 6, illustrated is a schematic flow diagram of a process 600 for bundling attributes and quote allocation, in accordance with one or more embodiments of the present disclosure. Herein, at block 602, the quote lines with variable considerations applied thereto are received. At block 604, the process 600 may check if the draft quotation has any of bundled quote lines or POB splits. If YES, at block 606, the attribution basis split is identified for each sub SKU and the corresponding attribution amount is calculated based on a rules engine (as represented by a block 608). If NO (or otherwise), the process 600 moves to block 610. At the block 610, the allocation amount for each SKU is determined in the draft quotation, including the sub SKUs in the bundles. Thereby, at block 612, the carve-ins and carve-outs are calculated, in reference to IND AS (if applicable).

Referring back to FIG. 2, at block 208, the processing arrangement is caused to determine revenue recognition for each of the groups of at least two items based on the price information and the determined revenue adjustment amount for each of the items therein. This, in general, includes calculating gross margins based on allocated revenue, i.e. revenue line amounts and cost amounts for each quote line. Further, at block 210, the processing arrangement is caused to generate a revenue forecast for the sales opportunity based on the determined revenue recognition for each of the groups of at least two items in the draft quotation. Herein, the system 200 may display, via a user interface, revenue waterfall for future periods based on start and end dates for ratable items and the like. Such steps may be contemplated by a person skilled in the art of accounting practices, and thus have not been explained in detail herein for the brevity of the present disclosure.

Further, as illustrated in FIG. 2, the generated revenue forecast information is sent to the API 250. In some embodiments, the system 200 may perform validations check. If passed, only then the generated revenue forecast information is sent. Further, the CRM application 220 receives the generated revenue forecast information from the API 250. As illustrated in FIG. 2, at block 242, the CRM application 220 may display the revenue allocations information for the draft quotation, for the consideration of the user. Herein, the revenue allocations information may include, but not limited to, Line No, Product Name, Quantity, Currency, Unit List Price, Unit Net Price, Line Amount, Variable Consideration, Net Allocable Price, Bundle Attribution Net, Allocation Amount, Total Cost, Gross Margin (Transaction Price), Gross Margin (Revenue), etc. Further, at block 244, the CRM application 220 may display the revenue forecast information for the life cycle of the draft quotation. Herein, the revenue forecast information may include, but not limited to, Line No, Product Name, Quantity, Currency, Unit Net Price, Allocation Amount, Period-wise Revenue Waterfall, etc. Such information may be displayed in custom pages by the CRM application 220. Based on the displayed information, at block 246, the user may provide approval on the draft quotation. At this point, the approved draft quotation may be chosen to be used as a quotation (quote) for sharing with the customer(s).

The present disclosure also relates to a computer-implemented method for determining potential revenue from a sales opportunity at a stage of generating a quotation therefor. Various embodiments and variants disclosed above apply mutatis mutandis to the present method.

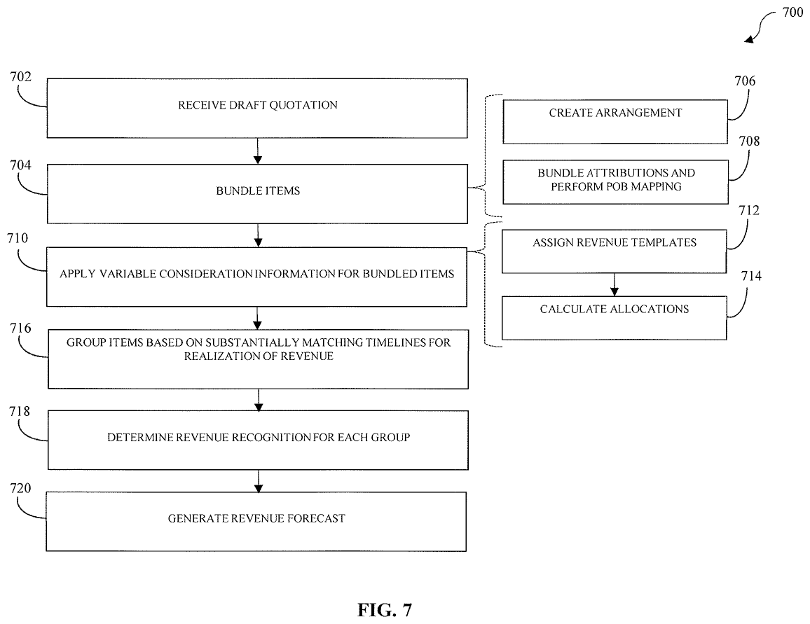

FIG. 7 illustrates a flowchart listing steps involved in a method 700 for determining potential revenue from a sales opportunity at a stage of generating a quotation therefor, in accordance with one or more embodiments of the present disclosure. At step 702, the method 700 includes receiving a draft quotation having a plurality of items, price information for each of the plurality of items and variable consideration information associated with each of the plurality of items therein. At step 704, the method 700 includes bundling, by the processing arrangement, two or more items from the plurality of items based, at least in part, on one or more predefined revenue allocation rules for the draft quotation. For executing the step 704, the method 700 involves creating an arrangement (at step 706), and bundling attributions and performing POB mapping (at step 708). At step 710, the method 700 includes applying, by the processing arrangement, the variable consideration information for each of the bundled two or more items to determine a revenue adjustment amount and a timeline for realization of revenue for each of the items in the bundled two or more items. For executing the step 710, the method 700 involves assigning revenue templates (at step 712), and thereafter calculate allocations (at step 714). At step 716, the method 700 includes grouping, by the processing arrangement, at least two items of the bundled two or more items based on substantially matching timelines therefor for realization of revenue therefrom. At step 718, the method 700 includes determining, by the processing arrangement, revenue recognition for each of the groups of at least two items based on the price information and the determined revenue adjustment amount for each of the items therein. At step 720, the method 700 includes generating, by the processing arrangement, a revenue forecast for the sales opportunity based on the determined revenue recognition for each of the groups of at least two items in the draft quotation.

As may be appreciated, providing revenue information at the time of quoting can eliminate manual calculation errors and save time and effort to users. The present system and method provide real-time revenue allocation, revenue forecasting, gross margin calculation and reporting on quotes based on ASC 606. This provides real-time integration of quote/modifications between CPQ (configure, price, quote) and revenue management. Thus, the present system and method provides accurate revenue calculations and enables companies to maintain their expected margins. This will improve the productivity of the users by eliminating manual activities. The present system and method may be implemented to automatically identify, analyze, allocate, calculate and schedule the revenue on a deal/quote in real-time. This dramatically transform speed and accuracy of a deal revenue assurance and approvals and faster deal closure cycles. Further, the present system and method provides comprehensive insights and support multiple “what-if scenario” analysis through managing multiple versions and audit history until the deal closure. The present system and method enable finance teams to scale up to different revenue recognition rules to support business growth strategies within increasingly demanding timeframes. In general, the present system and method provide revenue numbers for forecasting and allocations at the time of quoting to ensure right margins for quoted products and services, and thus enable finance team (CFO, VP Finance, controller etc.) to validate and approve quotes based on revenue numbers and margin.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. That memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

We claim:

1. A system for determining potential revenue from a sales opportunity at a stage of generating a quotation therefor, the system comprising:
an application programming interface configured to receive a draft quotation having a plurality of items, price information for each of the plurality of items and variable consideration information associated with each of the plurality of items therein;
a processing arrangement; and
a memory in signal communication with the processing arrangement, the memory storing computer-executable instructions, which, upon execution by the processing arrangement, cause the processing arrangement to:
bundle two or more items from the plurality of items based, at least in part, on one or more predefined revenue allocation rules for the draft quotation;
apply the variable consideration information for each of the bundled two or more items to determine a revenue adjustment amount and a timeline for realization of revenue for each of the items in the bundled two or more items;
group at least two items of the bundled two or more items based on substantially matching timelines therefor for realization of revenue therefrom;
determine revenue recognition for each of the groups of at least two items based on the price information and the determined revenue adjustment amount for each of the items therein; and
generate a revenue forecast for the sales opportunity based on the determined revenue recognition for each of the groups of at least two items in the draft quotation.

2. The system according to claim 1, wherein the variable consideration information comprises one or more parameters including one of rebate information, discount information and payment term information for each of the plurality of items in the draft quotation.

3. The system according to claim 1, wherein for applying the variable consideration information for each of the bundled two or more items, the processing arrangement is further caused to:
define one or more accounting rules to be applied to each of the bundled two or more items, as determined from the variable consideration information associated therewith; and
cascade the defined one or more accounting rules, for each of the items in the corresponding bundled two or more items.

4. The system according to claim 3, wherein the defined one or more accounting rules comprises at least one of amortization rule information and amortization method information for each of the corresponding bundled two or more items.

5. The system according to claim 1, wherein the one or more predefined revenue allocation rules are based on at least one of department information related to the sales opportunity, purchase order information related to the sales opportunity and region information related to the sales opportunity.

6. The system according to claim 2, wherein the revenue adjustment amount for a given item is determined based on one or more of the rebate information and the discount information for the corresponding given item, in the variable consideration information.

7. The system according to claim 2, wherein the one or more parameters related to the variable consideration information to be associated with each of the plurality of items in the draft quotation are defined based on corresponding rules based attributes for each of the plurality of items therein.

8. The system according to claim 2, wherein the processing arrangement is further caused to implement a natural language processing engine to analyze a term sheet for the draft quotation to determine the one or more parameters related to the variable consideration information associated with each of the plurality of items therein.

9. The system according to claim 2, wherein the processing arrangement is further caused to consider a rank of each of two or more conflicting parameters, in the variable consideration information, for any one of the items in the bundled two or more items while applying the variable consideration information.

10. The system according to claim 1, wherein grouping the at least two items of the bundled two or more items is further based on one or more predefined revenue recognition timeframes for the draft quotation, and wherein the one or more predefined revenue recognition timeframes are defined in any one of a day, a week, a month, a quarter and a year.

11. A computer-implemented method for determining potential revenue from a sales opportunity at a stage of generating a quotation therefor, the method comprising:
receiving a draft quotation having a plurality of items, price information for each of the plurality of items and variable consideration information associated with each of the plurality of items therein;
bundling, by a processing arrangement, two or more items from the plurality of items based, at least in part, on one or more predefined revenue allocation rules for the draft quotation;
applying, by the processing arrangement, the variable consideration information for each of the bundled two or more items to determine a revenue adjustment amount and a timeline for realization of revenue for each of the items in the bundled two or more items;
grouping, by the processing arrangement, at least two items of the bundled two or more items based on substantially matching timelines therefor for realization of revenue therefrom;
determining, by the processing arrangement, revenue recognition for each of the groups of at least two items based on the price information and the determined revenue adjustment amount for each of the items therein; and
generating, by the processing arrangement, a revenue forecast for the sales opportunity based on the determined revenue recognition for each of the groups of at least two items in the draft quotation.

12. The method according to claim 11, wherein the variable consideration information comprises one or more parameters including one of rebate information, discount information and payment term information for each of the plurality of items in the draft quotation.

13. The method according to claim 11, wherein applying the variable consideration information for each of the bundled two or more items further comprises:
defining, by the processing arrangement, one or more accounting rules to be applied to each of the bundled two or more items, as determined from the variable consideration information associated therewith; and
cascading, by the processing arrangement, the defined one or more accounting rules, for each of the items in the corresponding bundled two or more items.

14. The method according to claim 13, wherein the defined one or more accounting rules comprises at least one of amortization rule information and amortization method information for each of the corresponding bundled two or more items.

15. The method according to claim 11, wherein the one or more predefined revenue allocation rules are based on at least one of department information related to the sales opportunity, purchase order information related to the sales opportunity and region information related to the sales opportunity.

16. The method according to claim 12, wherein the revenue adjustment amount for a given item is determined based on one or more of the rebate information and the discount information for the corresponding given item, in the variable consideration information.

17. The method according to claim 12, wherein the one or more parameters related to the variable consideration information to be associated with each of the plurality of items in the draft quotation are defined based on corresponding rules based attributes for each of the plurality of items therein.

18. A computer program product comprising a non-transitory computer-readable storage medium having computer-readable instructions stored thereon, the computer-readable instructions being executable by a computerized device comprising processing hardware to execute a method as claimed in claim 11.
